(19) United States
(12) Patent Application Publication
(10) Pub. No.: US 2025/0193907 A1
(43) Pub. Date: Jun. 12, 2025

(54) USER EQUIPMENT AND METHOD FOR TRANSMITTING CHANNEL RETENTION SIGNAL IN SIDELINK COMMUNICATION

(71) Applicant: GUANGDONG OPPO MOBILE TELECOMMUNICATIONS CORP., LTD., Dongguan (CN)

(72) Inventor: Huei-Ming LIN, Taipei (TW)

(21) Appl. No.: 19/057,280

(22) Filed: Feb. 19, 2025

Related U.S. Application Data
(63) Continuation of application No. PCT/CN2023/128217, filed on Oct. 31, 2023.
(60) Provisional application No. 63/381,735, filed on Oct. 31, 2022.

(51) Int. Cl. H04W 72/25; H04L 5/00; H04L 27/26

(52) U.S. Cl. CPC H04W 72/25; H04L 5/0007; H04L 27/2678

(57) ABSTRACT

A method for transmitting channel retention signal (CRS) in sidelink (SL) communication by a user equipment (UE) includes transmitting, by the UE, one CRS from one or multiple CRS starting positions for a SL transmission within a first orthogonal frequency division multiplex (OFDM) symbol prior to a start of the SL transmission, wherein the one or multiple CRS starting positions for the SL transmission are configured and the SL transmission includes a SL synchronization signals block (S-SSB) transmission, a physical sidelink feedback channel (PSFCH) transmission, a physical sidelink shared channel (PSSCH) transmission, and/or a physical sidelink control channel (PSCCH) transmission.

### CROSS-REFERENCE TO RELATED APPLICATIONS

This application is a continuation of International Application No. PCT/CN2023/128217 filed on Oct. 31, 2023, which claims priority to U.S. Provisional Application No. 63/381,735 filed on Oct. 31, 2022. The contents of these applications are hereby incorporated by reference in their entireties.

### BACKGROUND

In the advancement of radio wireless transmission and reception directly between two devices, which is often known as device-to-device (D2D) communication, it is first developed by 3rd generation partnership project (3GPP) and introduced in Release 12 (officially specified as sidelink communication) and improved in Release 13 for public safety emergency usage such as mission critical communication to support mainly low data rate and voice type of connection. In 3GPP Releases 14, 15, and 16, the sidelink technology is advanced to additionally support vehicle-to-everything (V2X) communication as part of global development of intelligent transportation system (ITS) to boost road safety and advanced/autonomous driving use cases. To further expand the support of sidelink technology to wider applications and devices with limited power supply/battery, the technology is further enhanced in Release 17 in power saving and transceiver link reliability. In Release 18, 3GPP further evolved the wireless technology and expanded its operation into unlicensed frequency spectrum. This is for larger available bandwidth, faster data transfer rate, and easier market adoption of D2D communication using sidelink without requiring any mobile cellular operator's involvement to allocate and configure a part of their expansive precious radio spectrum for data services that do not go throughput their mobile networks.

There is no base station control and assistance to sidelink (SL) UEs in accessing unlicensed channel(s). Even in resource allocation (RA) Mode 1 under a gNB scheduling, the UEs may try to access the channel at different time and using different LBT channel access procedure with different channel idle period requirement. Under this type of operating scenario, it is not possible to coordinate in advanced among the UEs transmitting in the same slot to avoid access blocking/denying to the unlicensed channel.

Therefore, there is a need for a user equipment (UE) and a method for transmitting channel retention signal (CRS) in sidelink (SL) communication, which can solve issues in the prior art and other issues. SUMMARY

The present disclosure relates to the field of communication systems, and more particularly, to a user equipment (UE) and a method for transmitting channel retention signal (CRS) in sidelink (SL) communication, which can provide a good communication performance and/or provide high reliability.

In a first aspect of the present disclosure, a method for transmitting channel retention signal (CRS) in sidelink (SL) communication by a user equipment (UE) includes transmitting, by the UE, one CRS from one or multiple CRS starting positions for a SL transmission within a first orthogonal frequency division multiplex (OFDM) symbol prior to a start of the SL transmission, wherein the one or multiple CRS starting positions for the SL transmission are configured and the SL transmission includes a SL synchronization signals block (S-SSB) transmission, a physical sidelink feedback channel (PSFCH) transmission, a physical sidelink shared channel (PSSCH) transmission, and/or a physical sidelink control channel (PSCCH) transmission.

In a second aspect of the present disclosure, a user equipment (UE) includes a transmitter configured to transmit one CRS from one or multiple CRS starting positions for a SL transmission within a first orthogonal frequency division multiplex (OFDM) symbol prior to a start of the SL transmission, wherein the one or multiple CRS starting positions for the SL transmission are configured and the SL transmission includes a SL synchronization signals block (S-SSB) transmission, a physical sidelink feedback channel (PSFCH) transmission, a physical sidelink shared channel (PSSCH) transmission, and/or a physical sidelink control channel (PSCCH) transmission.

In a third aspect of the present disclosure, a non-transitory machine-readable storage medium has stored thereon instructions that, when executed by a user equipment (UE), cause the UE to perform an operation of: transmitting, by the UE, one channel retention signal (CRS) from one or multiple CRS starting positions for a sidelink (SL) transmission within a first orthogonal frequency division multiplex (OFDM) symbol prior to a start of the SL transmission, wherein the one or multiple CRS starting positions for the SL transmission are configured and the SL transmission comprises a SL synchronization signals block (S-SSB) transmission, a physical sidelink feedback channel (PSFCH) transmission, a physical sidelink shared channel (PSSCH) transmission, and/or a physical sidelink control channel (PSCCH) transmission.

### BRIEF DESCRIPTION OF DRAWINGS

In order to illustrate the embodiments of the present disclosure or related art more clearly, the following figures will be described in the embodiments are briefly introduced. It is obvious that the drawings are merely some embodiments of the present disclosure, a person having ordinary skill in this field can obtain other figures according to these figures without paying the premise.

FIG. 1 is a block diagram of user equipments (UEs) of communication in a communication network system according to an embodiment of the present disclosure.

FIG. 2 is a schematic diagram illustrating a user plane protocol stack according to an embodiment of the present disclosure.

FIG. 3 is a schematic diagram illustrating a control plane protocol stack according to an embodiment of the present disclosure.

FIG. 4 is a flowchart illustrating a method for transmitting channel retention signal (CRS) in sidelink (SL) communication between user equipments (UEs) according to an embodiment of the present disclosure.

FIG. 5 is a schematic diagram illustrating a proposed CRS transmission method for PSFCH and PSSCH/PSCCH transmissions with less than full bandwidth of an unlicensed channel according to an embodiment of the present disclosure.

FIG. 6 is a schematic diagram illustrating a proposed CRS transmission method for PSSCH/PSCCH based on a priority level or channel access priority class for transmissions with at least the full bandwidth of an unlicensed channel according to an embodiment of the present disclosure.

FIG. 7 is a block diagram of a UE for wireless communication according to an embodiment of the present disclosure.

FIG. 8 is a block diagram of an example of a computing device according to an embodiment of the present disclosure.

FIG. 9 is a block diagram of a system for wireless communication according to an embodiment of the present disclosure.

### DETAILED DESCRIPTION OF EMBODIMENTS

Embodiments of the present disclosure are described in detail with the technical matters, structural features, achieved objects, and effects with reference to the accompanying drawings as follows. Specifically, the terminologies in the embodiments of the present disclosure are merely for describing the purpose of the certain embodiment, but not to limit the disclosure.

### Shared/Unlicensed Spectrum

Shared (also referred as unlicensed or license-exempted) radio spectrum in 2.4 GHz and 5 GHz bands are commonly used by Wi-Fi and Bluetooth wireless technologies for short range communication (from just a few meters to few tens of meters). It is often claimed that more traffic is carried over the unlicensed spectrum bands than any other radio bands, since the frequency spectrum is free/at no-cost to use by anyone as long as the communication devices are compliant to certain local technical regulations. Besides Wi-Fi and Bluetooth, other radio access technologies (RATs) such as licensed-assisted access (LAA) based on 4G-LTE and new radio unlicensed (NR-U) based on 5G-NR mobile systems from 3GPP also operate in the same unlicensed bands. In order for devices of different RATs (Wi-Fi, Bluetooth, LAA, NR-U and possibly others) to operate simultaneously and coexistence fairly in the same geographical area without causing significant interference and interruption to each other's transmission, a clear channel access (CCA) protocol such as listen-before-talk (LBT) adopted in LAA and NR-U and carrier sense multiple access/collision avoidance (CSMA/CA) used in Wi-Fi and Bluetooth are employed before any wireless transmission is carried out to ensure that a wireless radio does not transmit while another is already transmitting on the same channel.

For the sidelink wireless technology, to also operate and coexistence with existing RATs already operating in the unlicensed bands, LBT based schemes may be employed to make certain there is no on-going activity on the radio channel before attempting to access the channel for transmission. For example, when a Type 1 LBT is successfully performed by a sidelink user equipment (UE), the UE has the right to access and occupy the unlicensed channel for a duration of a channel occupancy time (COT). During an acquired COT, however, a device of another RAT could still gain access to the channel if no wireless transmission is performed by the COT initiation sidelink UE or a COT responding sidelink UE for an idle period longer than 25 μs. Hence, potentially losing the access to the channel until another successful LBT is performed. A potential solution to this problem of losing the access to the channel could be a back-to-back (B2B) transmission.

### Mode 2 Resource Selection in Sidelink

In the existing design of resource allocation mechanism for SL communication, a Mode 2 resource selection method relies on the SL transmitting UE to perform autonomous selection of resources from a SL resource pool for its own transmission of data messages. In this method, the selection of transmission resources is not random but based on a sensing and reservation strategy to avoid collision with other SL transmission UEs operating in the same resource pool. In this resource selection strategy, a transmitting UE senses the channel within a sensing window (which is different from the LBT channel sensing) to detect and decode SL resource reservation information from other transmitting UEs. Based on the resource reservation information, the UE excludes some of the reserved resources from selection to avoid TX collision. Likewise, the UE also sends out/broadcast its own resource reservation information in the resource pool when it transmits data and control messages so that other UEs will avoid selecting the same resource. In the existing resource selection and reservation signaling design, the time gap between two consecutive resources can be up to 31 slots apart. With this type of resource selection method, it is not ideal for B2B transmission as there is no guarantee that resources will be selected contiguously in time.

### Unlicensed Channel Access and Occupancy

A Type 1 LBT procedure can be perform by a UE before any SL transmission to first gain an access to an unlicensed channel and to initiate a COT. Additionally, a B2B transmission could be used to avoid large transmission gaps in order to retain the COT and the access to the channel. Beside the Type 1 LBT, a Type 2 LBT could be also used by the UE during a COT or a shared COT as required by unlicensed spectrum regulation for gaps that are 25 μs or smaller. For example, in a Type 2A LBT if an unlicensed channel is sensed to be idle for 25 μs or more, the COT initiating UE is permitted to resume its transmission and/or a COT sharing UE is allowed to start its transmission within a COT. In a Type 2B LBT, the allowed transmission gap is 16 μs and Type 2C LBT (for which the UE does not need to perform channel sensing) is for gaps less than 16 μs.

In NR-U and LAA system, transmission gaps are unavoidable/inevitable before UE occupying the unlicensed channel due to propagation delay between gNB/gNB to the UEs in sending scheduling control information, UE switching from a receiving mode (RX) to a transmitting mode (TX), and data information encoding and modulation for an actual uplink (UL) transmission. Sometimes, these gaps could be larger than 25 μs and an extension of cyclic prefix may be first transmitted in the UL in order to avoid the unlicensed channel being taken over by other devices operating in the same spectrum band due to excessive channel idle time). The duration of a cyclic prefix extension (CPE) transmission in the UL is determined by the base station (gNB/eNB) to avoid any access blocking/denying issue among different UEs. In addition, it is indicated to each scheduled UE, and the UE simply follows the indication and performs UL transmission accordingly.

In SL communication, especially in resource allocation (RA) Mode 2, all transmission resources are to be determined and selected by the UE on its own without any base station intervention, assistance and coordination to avoid transmission collisions. Furthermore, the SL system enables frequency domain multiplexing (FDM) of transmissions from multiple UEs in the same slot such that radio resource utilization efficiency is maximized and shortened the communication latency at the same time. But since there is no base station control and assistance to SL UEs in accessing the unlicensed channel(s), even in RA Mode 1 under a gNB scheduling, the UEs may try to access the channel at different time and using different LBT channel access procedure with different channel idle period requirement. Under this type of operating scenario, it is not possible to coordinate in advanced among the UEs transmitting in the same slot to avoid access blocking/denying to the unlicensed channel.

In some embodiments, for the present proposed methods in accessing and retaining access to an unlicensed channel, and at the same time resolving the channel access prevention problem among different SL TX UEs, the principal mechanism is to transmit a channel retention signal (CRS) so that the access to the unlicensed channel is maintained for the intended SL transmission. Other benefits from transmitting CRS in the unlicensed channel according to the proposed methods may include: 1. Avoiding SL transmission collision in the case when the intended SL transmission occupies at least full bandwidth of a channel based on a priority-based access. 2. The CRS transmission can be flexibly adjusted to prioritize FDM or TDM based transmission according to the application and use case (e.g., TDM based setting for data intensive applications and FDM based setting for latency sensitive usage).

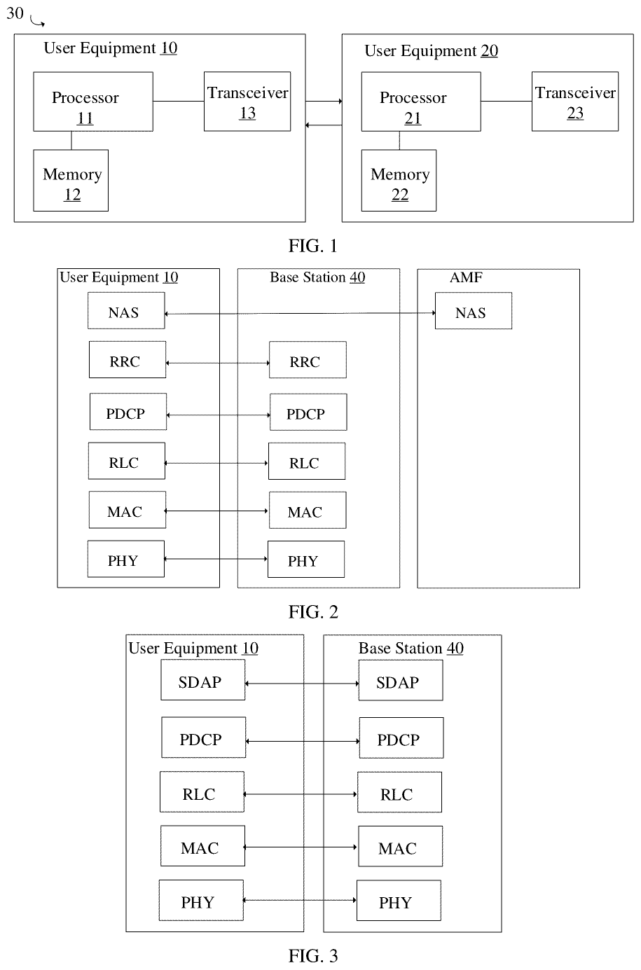

FIG. 1 illustrates that, in some embodiments, one or more user equipments (UEs) 10 (such as a first UE) and one or more user equipments (UEs) 20 (such as a second UE) of communication in a communication network system 30 according to an embodiment of the present disclosure are provided. The communication network system 30 includes one or more UEs 10 and one or more UE 20. The UE 10 may include a memory 12, a transceiver 13, and a processor 11 coupled to the memory 12 and the transceiver 13. The UE 20 may include a memory 22, a transceiver 23, and a processor 21 coupled to the memory 22 and the transceiver 23. The processor 11 or 21 may be configured to implement proposed functions, procedures and/or methods described in this description. Layers of radio interface protocol may be implemented in the processor 11 or 21. The memory 12 or 22 is operatively coupled with the processor 11 or 21 and stores a variety of information to operate the processor 11 or 21. The transceiver 13 or 23 is operatively coupled with the processor 11 or 21 and transmits and/or receives a radio signal.

The processor 11 or 21 may include application-specific integrated circuit (ASIC), other chipset, logic circuit and/or data processing device. The memory 12 or 22 may include read-only memory (ROM), random access memory (RAM), flash memory, memory card, storage medium and/or other storage device. The transceiver 13 or 23 may include baseband circuitry to process radio frequency signals. When the embodiments are implemented in software, the techniques described herein can be implemented with modules (e.g., procedures, functions, and so on) that perform the functions described herein. The modules can be stored in the memory 12 or 22 and executed by the processor 11 or 21. The memory 12 or 22 can be implemented within the processor 11 or 21 or external to the processor 11 or 21 in which case those can be communicatively coupled to the processor 11 or 21 via various means as is known in the art.

The communication between UEs relates to vehicle-to-everything (V2X) communication including vehicle-to-vehicle (V2V), vehicle-to-pedestrian (V2P), and vehicle-to-infrastructure/network (V2I/N) according to a sidelink technology developed under 3rd generation partnership project (3GPP) long term evolution (LTE) and new radio (NR) releases 17, 18 and beyond. UEs are communicated with each other directly via a sidelink interface such as a PC5 interface. Some embodiments of the present disclosure relate to sidelink communication technology in 3GPP NR releases 19 and beyond, for example providing cellular-vehicle to everything (C-V2X) communication.

In some embodiments, the UE 10 may be a sidelink packet transport block (TB) transmission UE (Tx-UE). The UE 20 may be a sidelink packet TB reception UE (Rx-UE) or a peer UE. The sidelink packet TB Rx-UE can be configured to send ACK/NACK feedback to the packet TB Tx-UE. The peer UE 20 is another UE communicating with the Tx-UE 10 in a same SL unicast or groupcast session.

FIG. 2 illustrates an example user plane protocol stack according to an embodiment of the present disclosure. FIG. 2 illustrates that, in some embodiments, in the user plane protocol stack, where service data adaptation protocol (SDAP), packet data convergence protocol (PDCP), radio link control (RLC), and media access control (MAC) sublayers and physical (PHY) layer (also referred as first layer or layer 1 (L1) layer) may be terminated in a UE 10 and a base station 40 (such as gNB) on a network side. In an example, a PHY layer provides transport services to higher layers (e.g., MAC, RRC, etc.). In an example, services and functions of a MAC sublayer may comprise mapping between logical channels and transport channels, multiplexing/demultiplexing of MAC service data units (SDUs) belonging to one or different logical channels into/from transport blocks (TBs) delivered to/from the PHY layer, scheduling information reporting, error correction through hybrid automatic repeat request (HARQ) (e.g. one HARQ entity per carrier in case of carrier aggregation (CA)), priority handling between UEs by means of dynamic scheduling, priority handling between logical channels of one UE by means of logical channel prioritization, and/or padding. A MAC entity may support one or multiple numerologies and/or transmission timings. In an example, mapping restrictions in a logical channel prioritization may control which numerology and/or transmission timing a logical channel may use. In an example, an RLC sublayer may supports transparent mode (TM), unacknowledged mode (UM) and acknowledged mode (AM) transmission modes. The RLC configuration may be per logical channel with no dependency on numerologies and/or transmission time interval (TTI) durations. In an example, automatic repeat request (ARQ) may operate on any of the numerologies and/or TTI durations the logical channel is configured with. In an example, services and functions of the PDCP layer for the user plane may comprise sequence numbering, header compression, and decompression, transfer of user data, reordering and duplicate detection, PDCP PDU routing (e.g., in case of split bearers), retransmission of PDCP SDUs, ciphering, deciphering and integrity protection, PDCP SDU discard, PDCP re-establishment and data recovery for RLC AM, and/or duplication of PDCP PDUs. In an example, services and functions of SDAP may comprise mapping between a QoS flow and a data radio bearer. In an example, services and functions of SDAP may comprise mapping quality of service Indicator (QFI) in downlink (DL) and uplink (UL) packets. In an example, a protocol entity of SDAP may be configured for an individual PDU session.

FIG. 3 illustrates an example control plane protocol stack according to an embodiment of the present disclosure. FIG. 3 illustrates that, in some embodiments, in the control plane protocol stack where PDCP, RLC, and MAC layers and PHY layer may be terminated in a UE 10 and a base station 40 (such as gNB) on a network side and perform service and functions described above. In an example, radio resource control (RRC) used to control a radio resource between the UE and a base station (such as a gNB). In an example, RRC may be terminated in a UE and the gNB on a network side. In an example, services and functions of RRC may comprise broadcast of system information related to access stratum (AS) and non-access stratum (NAS), paging initiated by 5G core network (5GC) or radio access network (RAN), establishment, maintenance and release of an RRC connection between the UE and RAN, security functions including key management, establishment, configuration, maintenance and release of signaling radio bearers (SRBs) and data radio bearers (DRBs), mobility functions, QoS management functions, UE measurement reporting and control of the reporting, detection of and recovery from radio link failure, and/or non-access stratum (NAS) message transfer to/from NAS from/to a UE. In an example, NAS control protocol may be terminated in the UE and AMF on a network side and may perform functions such as authentication, mobility management between a UE and an access and mobility management function (AMF) for 3GPP access and non-3GPP access, and session management between a UE and a SMF for 3GPP access and non-3GPP access.

When a specific application is executed and a data communication service is required by the specific application in the UE, an application layer taking charge of executing the specific application provides the application-related information, that is, the application group/category/priority information/ID to the NAS layer. In this case, the application-related information may be pre-configured/defined in the UE. (Alternatively, the application-related information is received from the network to be provided from the AS (RRC) layer to the application layer, and when the application layer starts the data communication service, the application layer requests the information provision to the AS (RRC) layer to receive the information.)

In some embodiments, the processor 11 is configured to transmit one CRS from one or multiple CRS starting positions for a SL transmission within a first orthogonal frequency division multiplex (OFDM) symbol prior to a start of the SL transmission, wherein the one or multiple CRS starting positions for the SL transmission are configured and the SL transmission includes a SL synchronization signals block (S-SSB) transmission, a physical sidelink feedback channel (PSFCH) transmission, a physical sidelink shared channel (PSSCH) transmission, and/or a physical sidelink control channel (PSCCH) transmission. This can solve issues in the prior art and other issues, and/or improve SL communication performance and reliability.

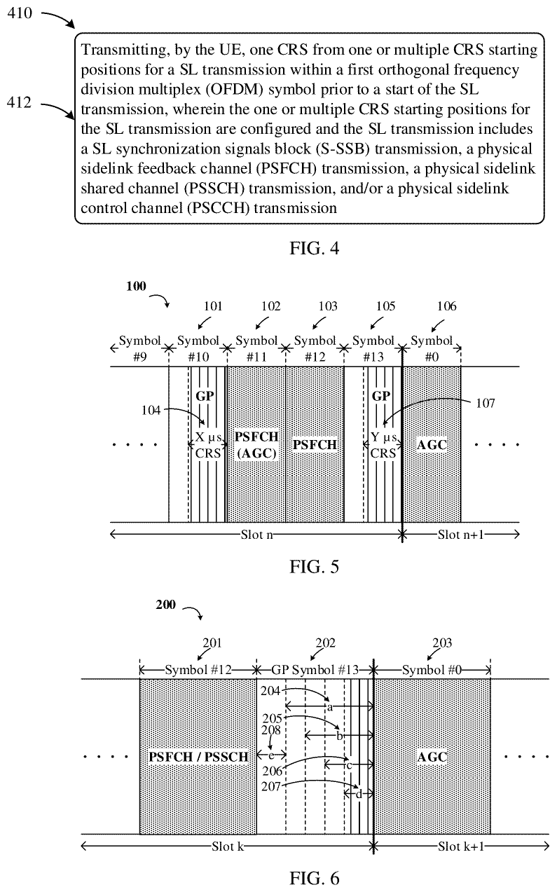

FIG. 4 illustrates a method 410 for channel access and occupancy in a shared spectrum between user equipments (UEs) according to an embodiment of the present disclosure. In some embodiments, the method 410 includes: an operation 412, transmitting, by the UE, one CRS from one or multiple CRS starting positions for a SL transmission within a first orthogonal frequency division multiplex (OFDM) symbol prior to a start of the SL transmission, wherein the one or multiple CRS starting positions for the SL transmission are configured and the SL transmission includes a SL synchronization signals block (S-SSB) transmission, a physical sidelink feedback channel (PSFCH) transmission, a physical sidelink shared channel (PSSCH) transmission, and/or a physical sidelink control channel (PSCCH) transmission. This can solve issues in the prior art and other issues, and/or improve SL communication performance and reliability.

In some embodiments, the one CRS starting position for the S-SSB transmission, the PSFCH transmission, the PSSCH transmission, and/or the PSCCH transmission is configured from one of pre-defined candidate starting positions. In some embodiments, the one CRS starting position for the S-SSB transmission within the first OFDM symbol prior to a start of the S-SSB transmission is common for UEs. In some embodiments, the one CRS starting position for the PSFCH transmission, the PSSCH transmission, and/or the PSCCH transmission within the first OFDM symbol prior to a start of an automatic gain control (AGC) symbol for the PSFCH transmission, the PSSCH transmission, and/or the PSCCH transmission is common for UEs. In some embodiments, a selection of the one CRS starting position for the PSSCH transmission and/or the PSCCH transmission is based on the PSSCH transmission and/or the PSCCH transmission occupying less than a full bandwidth of a shared/unlicensed channel.

In some embodiments, the one CRS for the S-SSB transmission, the PSFCH transmission, the PSSCH transmission, and/or the PSCCH transmission is transmitted a time length before an automatic gain control (AGC) symbol for the S-SSB transmission, the PSFCH transmission, the PSSCH transmission, and/or the PSCCH transmission or before a first symbol of the S-SSB transmission, the PSFCH transmission, the PSSCH transmission, and/or the PSCCH transmission. In some embodiments, for 15 kHz sub-carrier spacing (SCS) and/or 30 kHz SCS, the one CRS starting position for the S-SSB transmission, the PSFCH transmission, the PSSCH transmission, and/or the PSCCH transmission is determined by (an OFDM symbol length−34 μs), (the OFDM symbol length−25 μs), or (the OFDM symbol length−16 μs). In some embodiments, for 60 kHz SCS, the one CRS starting position for the S-SSB transmission, the PSFCH transmission, the PSSCH transmission, and/or the PSCCH transmission is determined by (an OFDM symbol length−16 μs).

In some embodiments, the one CRS for the S-SSB transmission, the PSFCH transmission, the PSSCH transmission, and/or the PSCCH transmission includes a repetition or an extension of a cyclic prefix of the AGC symbol for the S-SSB transmission, the PSFCH transmission, the PSSCH transmission, and/or the PSCCH transmission or a repetition or an extension of a cyclic prefix of the first symbol of the S-SSB transmission, the PSFCH transmission, the PSSCH transmission, and/or the PSCCH transmission. In some embodiments, the multiple CRS starting positions for the PSSCH transmission and/or the PSCCH transmission are configured from a set of pre-defined candidate starting positions. In some embodiments, the multiple CRS starting positions for the PSSCH transmission and/or the PSCCH transmission are configured based on first layer (L1) priority levels. In some embodiments, in the L1 priority levels, for a first priority level higher than a second priority level, a CRS time length duration of the first priority level is longer than CRS time length duration of the second priority level.

In some embodiments, the term “/” can be interpreted to indicate “and/or.” The term “configured” can refer to “pre-configured” and “network configured”. The term “pre-defined” or “pre-defined rules” in the present disclosure may be achieved by pre-storing corresponding codes, tables, or other manners for indicating relevant information in devices (e.g., including a UE and a network device). The specific implementation is not limited in the present disclosure. For example, “pre-defined” may refer to those defined in a protocol. It is also to be understood that in the disclosure, “protocol” may refer to a standard protocol in the field of communication, which may include, for example, an LTE protocol, NR protocol and relevant protocol applied in the future communication system, which is not limited in the present disclosure.

### EXAMPLES

In some embodiments, according to inventive methods for accessing and retaining access to an unlicensed channel in sidelink (SL) communication, one of the key objectives is to avoid the channel access prevention issue, where a transmission from one user equipment (UE) while trying to access or retaining an access is barring another UE's attempt to access the channel. For this issue, it may cause a severe consequence and performance impact to the SL communication due to one of the key design principals of using the sidelink technology is to allow and encourage frequency domain multiplexing (FDM) of different UE's data transmissions in a same slot in one scenario and feedback information in same symbols in another scenario. One of the key benefits of having this FDM capability in SL communication is to maximize the utilization of precious frequency resources. Depending on the application and use case, it is not expected that all SL transmissions will always have a large packet size and require full channel bandwidth transmission, for which the transmissions from different UEs can only be time domain multiplexed (TDM). Even for an application that often has a high throughput requirement for the data delivery, devices often still require to transmit control and signaling messages to maintain the connection with one another, for which the packets are typically small in size. Hence, the ability to FDM different transmissions in the same slot/symbols may help to enhance the utilization of frequency resource more efficiently, instead of always TDM just like the Wi-Fi system.

The second major benefit of being able to FDM transmissions from different UEs in the same slot/symbols is to shorten the transmission latency in delivering data packets when they do not require full channel bandwidth, instead of transmitting/delivering only one packet in each time slot. By reducing the communication delay, the sidelink technology can be used to support more time critical services and applications such as medical, mission critical, AR/VR applications, etc.

Furthermore, the SL sensing and reservation mechanism in the Mode 2 resource allocation of SL communication is to allow different UEs to coexist harmoniously and operate without collision in a same channel by selecting a non-conflict resource to another UE's resource reservation. Hence, this is the key mechanism in enabling the simultaneous transmission from multiple different UEs in the same slot and symbols in the FDM manner. If the FDM feature is no longer supported in SL communication, the channel access and resource allocation will become a competition among all SL transmitting UEs in a “first come first access” TDM manner. In the worst case, packets with lowest assigned priority class will never get to access and transmit on the channel. When the channel is congested with many devices operating simultaneously in the same area, the data rate and user experience are usually unsatisfactory.

In SL communication, certain symbols within a SL slot and at the slot boundary are designated as a guard period (GP) symbol in the existing SL frame structure design. These GP symbols are to be kept empty and not intended for any transmission at all for the purposes of radio frequency (RF) component operation switching time from a transmit (TX) mode to a receive (RX) mode (and vice-versa) and accommodating a timing advance (TA) for transmitting uplink (UL) in the following time slot. For SL communication operating in an unlicensed spectrum/channel, these GP symbols (i.e., transmission gaps) could be also used for listen-before-talk (LBT) sensing in channel access procedures in order for UEs to gain access to the unlicensed channel and perform transmission in the following symbol or time slot. However, depending on the system sub-carrier spacing (SCS) for SL communication, these GP symbols (transmission gaps) could be too large as the required channel idle time is only 25 μs for the Type 2A channel access procedure and 16 μs only for the Type 2B/2C. For example, the GP symbol length is around 70 μs when SCS is 15 kHz, 35 μs for 30 kHz SCS and 17.5 μs for 60k Hz SCS. As can be seen, the GP symbol lengths at least in the 15 kHz and 30 kHz SCS are larger than the required LBT sensing period and creates an opportunity for other radio access technology device to start its transmission and take over the channel as such.

For the 5th generation (5G) new radio system operating in an unlicensed channel (NR-U), as explained earlier, size of the transmission gap between gNB scheduling until UL transmission by a UE can be flexibly control by the gNB and minimized by UE transmitting an extension of cyclic prefix if Type 1 LBT channel access procedure finishes before the scheduled transmission. For the SL operation in the unlicensed spectrum (SL-U), however, there is a lacking of a centralized management and coordination in the channel access, since everything (from resource selection to channel access decision) is determined in a distributed manner by the individual UE in the system, which will likely result in preventing each other's access to the unlicensed channel. If purely using priority-based access, the channel access for lower priority will be always prevented by higher priority transmissions, and thus causing delay and the SL system may be operating in a time domain multiplexing (TDM) manner which should be avoided.

In the following, detailed description of the proposed effective methods of accessing and retaining access to an unlicensed channel in SL-U communication by transmitting a channel retention signal (CRS) before the start of the following SL transmission is provided for different operating scenarios, while supporting FDM operation of simultaneous transmissions from multiple UEs in a same time slot and symbols (multiplexing transmissions from different UEs in the frequency domain resources).

### Exemplary Method 1: A Single/Common CRS Transmission Scheme for PSFCH/S-SSB and PSSCH/PSCCH With Less Than Full Shared Channel Bandwidth (S_{RB})

In SL communication, several physical channels and signals are transmitted from a UE, such as physical sidelink control channel (PSCCH) for resource reservation and scheduling physical sidelink shared channel (PSSCH) transmission(s), PSSCH for delivering data messages, physical sidelink feedback channel (PSFCH) for reporting SL hybrid automatic repeat request (SL-HARQ) information from a RX UE to a TX UE, and SL synchronization signals block (S-SSB) for timing synchronization purpose. The resource allocation, transmit timing occasion, and starting orthogonal frequency division multiplex (OFDM) symbol within a slot are different among these SL channels and signals.

### S-SSB

For the case of S-SSB, two S-SSB resource occasions are configured every 160 ms for a UE (one of which is configured for transmission and the other for reception). The same set of S-SSB resource occasions are common in a SL system, meaning all UEs use the same set of resources and have the same transmission and reception timings. As such, just prior to the S-SSB transmission in SL-U, all UEs should perform the same type of channel access procedure (due to the channel idle time requirement) or at least having the same time gap between the end of the last SL transmission to the beginning of S-SSB transmission.

In order to achieve this, it is proposed to transmit a CRS in a OFDM symbol (which could be a GP symbol) prior to the start of the S-SSB transmission in order to gain access or retain an access to the unlicensed/shared channel according to the following (pre-)configurations, and transmission rules and conditions.

The transmission of CRS can be applied in conjunction with Type 1 channel access procedure in order to gain access to the unlicensed channel for transmitting S-SSB, or the CRS is applied in conjunction with Type 2A/2B/2C channel access procedure in order to retain an access to the unlicensed channel for transmitting S-SSB. In the case of the Type 1 channel access procedure, due to the unpredictable nature of the random count down process and thus the procedure completion time, in most cases the UE will start the Type 1 channel access procedure a little earlier to account for some buffer time and to ensure the procedure will complete before the S-SSB transmission. When the procedure does finish earlier than the starting time of the S-SSB transmission, the UE will need to perform a short LBT for at least 34 μs just before the S-SSB transmission to ensure the channel is still idle and hence available for transmission. At the same time, other UEs may apply Type 2A or 2B channel access procedure which requires a LBT length of 25 μs and 16 μs in a shared channel occupancy time (COT) scenario, respectively. But since none of these mandated channel idle times is longer than a OFDM symbol, it would be necessary to transmit a CRS to fill the gap such that the remaining time within the OFDM symbol (GP symbol) can be used for Type 1 and Type 2 channel access procedures.

In some examples, the CRS for S-SSB is transmitted Z μs before the AGC symbol for S-SSB or the first symbol of S-SSB. That is, the length duration/starting position of the CRS for S-SSB is Z μs. In some examples, the time length/starting position of the CRS for S-SSB (Z μs) is pre-defined or (pre-)configured to a SL UE. In some examples, the same time length/a single starting position of the CRS for S-SSB (Z μs) within the OFDM symbol prior to the start of the S-SSB could be common for all UEs in the SL system.

In some examples, for 15 kHz and 30 k Hz SL SCS, the time length/starting position could be determined by either (Z=OFDM symbol length−34 μs), (Z=OFDM symbol length−25 μs), or (Z=OFDM symbol length−16 μs). In some examples, for 60 KHz SL SCS, since the total length of a OFDM symbol is only around 17.5 μs (which is less than 25 μs channel idle sensing time requirement for Type 2A channel access procedure), it may not be necessary to apply/transmit a CRS before S-SSB. If applied, Z could be determined by (Z=OFDM symbol length−16 μs).

In some examples, the content/component of the CRS for S-SSB could be made out of one of the following options: Option 1: A repetition of the first Z μs of the AGC symbol for S-SSB. Option 2: A repetition of the first Z μs of the first symbol of S-SSB. Option 3: A repetition or an extension of the cyclic prefix of the AGC symbol for S-SSB or cyclic prefix of the first symbol of S-SSB.

### PSFCH

In some embodiments, for the case of PSFCH, 3 OFDM symbols are allocated in a time slot with a total of 14 symbols for the purpose of transmitting PSFCH from a RX UE. As illustrated in diagram 100 of FIG. 5, symbol index #10 101 is designated as a guard period symbol to allow for TX/RX switching from a PSFCH receiving UE's perspective and RX/TX switching from a PSFCH transmitting UE's perspective. Therefore, this GP symbol is a gap in SL transmission and hence other devices could potentially try to access the unlicensed channel during this transmission gap if it is larger than 25 μs. Symbol index #11 102 and #12 103 are designated for PSFCH transmission but both symbols contain exactly the same information (one is a replica of the other) and symbol #11 102 is meant to be used as an automatic gain control (AGC) symbol at the PSFCH receiver. Therefore, it is sometimes known and referred as the AGC symbol for PSFCH and symbol #12 103 is used for decoding and extracting the actual PSFCH information. It should be also noted that the PSFCH symbols comprises of PSFCH resources that can be used by multiple UEs to report their SL-HARQ feedback information. Thus, these are OFDM symbols that contain PSFCH transmission from multiple UEs and these UEs could all gain access to the unlicensed channel at the same time to perform their transmissions. Therefore, just prior to the PSFCH transmission in symbol #11 102 in SL-U, all UEs could perform the same type of channel access procedure (due to the channel idle time requirement) or at least having the same time gap between the end of the last SL transmission to the beginning of the PSFCH transmission in symbol #11 102.

In order to achieve this, it is proposed to transmit a CRS in OFDM symbol #10 101 prior to the start of the PSFCH transmission (i.e., AGC symbol 102) in order to gain access or retain an access to the unlicensed/shared channel according to the following (pre-)configurations, and transmission rules and conditions.

Similar to the S-SSB case, the transmission of CRS for PSFCH can be applied in conjunction with Type 1 channel access procedure in order to gain access to the unlicensed channel, or the CRS for PSFCH is applied in conjunction with Type 2A/2B/2C channel access procedure in order to retain an access to the unlicensed channel. In the case of the Type 1 channel access procedure, due to the unpredictable nature of the random count down process and thus the procedure completion time, in most cases the UE may start the Type 1 channel access procedure a little earlier to account for some buffer time and to ensure the procedure may complete before the PSFCH transmission. When the procedure does finish earlier than the starting time of the PSFCH transmission, the UE may need to perform a short LBT for at least 34 μs just before the PSFCH transmission to ensure the channel is still idle and hence available for transmission. At the same time, other UEs may apply Type 2A or 2B channel access procedure which requires a LBT length of 25 μs and 16 μs in a shared COT scenario, respectively. But since none of these mandated channel idle times is longer than a OFDM symbol, it would be necessary to transmit a CRS to fill the gap such that the remaining time within the OFDM symbol (GP symbol #10 (101)) can be used for Type 1 and Type 2 channel access procedures.

In some examples, the CRS for PSFCH is transmitted X μs before the PSFCH AGC symbol #11 102. That is, the length duration/starting position of the CRS for PSFCH is X μs. In some examples, the time length/starting position of the CRS for PSFCH (X μs) is pre-defined or (pre-)configured to a SL UE. In some examples, the same time length/a single starting position of the CRS for PSFCH (X μs) within the GP symbol #10 101 prior to the start of the PSFCH AGC symbol #11 102 could be common for all UEs in the SL system. In some examples, although the scenario of PSFCH transmission is similar to the case of S-SSB transmission in SL, the X μs CRS time length/starting position for PSFCH could be the same or different to the Z μs time length/starting position for S-SSB.

In some examples, for 15 kHz and 30 KHz SL SCS, the time length/starting position could be determined by either (X=OFDM symbol length−34 μs), (X=OFDM symbol length−25 μs), or (X=OFDM symbol length−16 μs). In some examples, for 60 KHz SL SCS, since the total length of a OFDM symbol is only around 17.5 μs (which is less than 25 μs channel idle sensing time requirement for Type 2A channel access procedure), it may not be necessary to apply/transmit a CRS before PSFCH. If applied, X could be determined by (X=OFDM symbol length-16 μs).

In some examples, the content/component of the CRS for PSFCH could be made out of one of the following options: Option A: A repetition of the first X μs of the PSFCH AGC symbol #11 102. Option B: A repetition or an extension of the cyclic prefix of the PSFCH AGC symbol #11 102.

### PSSCH/PSCCH

For the case of PSSCH/PSCCH, there can be two different starting symbols within a time slot for transmitting PSSCH/PSCCH, the first one at the beginning of a time slot and the second one at a different symbol (e.g., OFDM symbol #7 within a slot). In SL-U, a new second starting symbol is introduced to provide more opportunities for UE to start transmitting PSSCH/PSCCH such that the UE is able to access and occupy the unlicensed channel earlier before it is taken over by other devices. For the first PSSCH/PSCCH starting symbol within a time slot, symbol #0 106 in slot n+1 as illustrated in diagram 100 in FIG. 5, it is always right after a GP symbol #13 (105) at the end of the previous slot n and the starting symbol is always designated as a AGC symbol.

In some embodiments, for the new second starting symbol within a time slot for PSSCH/PSCCH transmission, there may be no GP symbol (i.e., no gap in SL transmission) right before it, due to the purpose of introducing a new starting symbol is for UE performing Type 1 channel access procedure. If a UE could complete a Type 1 channel access procedure within a time slot and before the second starting symbol, it means there is no on-going transmission within the slot. And hence, the channel is empty and available for access by any device. In this case, there is no need to designate a GP symbol right before the new second starting symbol. As such, transmitting a CRS to reduce a transmission gap seems not necessary. If a GP symbol is introduced and allocated in the OFDM symbol right before the new second starting symbol within a time slot (e.g., for the purpose of supporting UE performing Type 2 channel access procedure), the CRS transmission for the first starting symbol would equally apply for the new second starting symbol in the GP symbol immediately prior. Note that, the new second starting symbol is also designated as a AGC symbol for PSSCH/PSCCH transmission.

Using the first starting symbol for PSSCH/PSCCH transmission as an example, as illustrated in diagram 100 of FIG. 5, symbol index #13 105 is designated as a guard period (GP) symbol at the end of slot n. Therefore, this GP symbol is a gap in SL transmission and hence other devices could potentially try to access the unlicensed channel during this transmission gap if it is larger than 25 μs. Similar to PSFCH transmissions, the frequency resources within the unlicensed channel bandwidth in the symbols allocated for PSSCH/PSCCH transmission can be used by multiple UEs simultaneously in the same slot in a FDM manner, as described earlier. Therefore, the UEs could all gain access to the unlicensed channel at the same time to perform their transmissions.

In order to achieve this, it is proposed to transmit a CRS in OFDM symbol #13 105 prior to the start of the PSSCH/PSCCH transmission (i.e., AGC symbol 106) in order to gain access or retain an access to the unlicensed/shared channel according to the following (pre-)configurations, and transmission rules and conditions.

Similar to the PSFCH case, the transmission of CRS for PSSCH/PSCCH can be applied in conjunction with Type 1 channel access procedure in order to gain access to the unlicensed channel, or the CRS for PSSCH/PSCCH is applied in conjunction with Type 2A/2B/2C channel access procedure in order to retain an access to the unlicensed channel. In the case of the Type 1 channel access procedure, due to the unpredictable nature of the random count down process and thus the procedure completion time, in most cases the UE will start the Type 1 channel access procedure a little earlier to account for some buffer time and to ensure the procedure will complete before the PSSCH/PSCCH transmission. When the procedure does finish earlier than the starting time of the PSSCH/PSCCH transmission, the UE may perform a short LBT for at least 34 μs just before the PSSCH/PSCCH transmission to ensure the channel is still idle and hence available for transmission. At the same time, other UEs may apply Type 2A or 2B channel access procedure which requires a LBT length of 25 μs and 16 μs in a shared COT scenario, respectively. But since none of these mandated channel idle times is longer than a OFDM symbol, it would be necessary to transmit a CRS to fill the gap such that the remaining time within the OFDM symbol (GP symbol #13 105) can be used for Type 1 and Type 2 channel access procedures.

In some examples, the CRS for PSSCH/PSCCH is transmitted Y μs before the PSSCH/PSCCH AGC symbol #0 106 of slot n+1. That is, the length duration/starting position of the CRS for PSSCH/PSCCH is Y μs. In some examples, the time length/starting position of the CRS for PSSCH/PSCCH (Y μs) is pre-defined or (pre-)configured to a SL UE. In some examples, the same time length/a single starting position of the CRS for PSSCH/PSCCH (Y μs) within the GP symbol #13 105 prior to the start of the PSSCH/PSCCH AGC symbol #0 106 in slot n+1 could be common for all UEs in the SL system at least to achieve sharing of frequency resources in a FDM manner. That is, when the PSSCH/PSCCH transmission is occupying a set of resource blocks that is less than the full bandwidth of a shared/unlicensed channel (SRB), meaning it is possible to have PSSCH/PSCCH transmission using other frequency resource from at least another UE in the same slot, it is necessary to apply a single/common CRS time length/starting position among all PSSCH/PSCCH transmitting UEs.

Although the scenario of PSSCH/PSCCH transmission is similar to the case of S-SSB and PSFCH transmissions in SL, the Y μs CRS time length/starting position for PSSCH/PSCCH could be the same or different to the Z μs and Y μs time length/starting position for S-SSB and PSFCH, respectively.

In some examples, for 15kHz and 30 kHz SL SCS, the time length/starting position could be determined by either (Y=OFDM symbol length−34 μs), (Y=OFDM symbol length−25 μs), or (Y=OFDM symbol length−16 μs). In some examples, for 60KHz SL SCS, since the total length of a OFDM symbol is only around 17.5 μs (which is less than 25 μs channel idle sensing time requirement for Type 2A channel access procedure), it may not be necessary to apply/transmit a CRS before PSSCH/PSCCH. If applied, Y could be determined by (Y=OFDM symbol length−16 μs).

In some examples, the content/component of the CRS for PSSCH/PSCCH could be made out of one of the following options: Option K: A repetition of the first Y μs of the PSSCH/PSCCH AGC symbol #0 106. Option L: A repetition or an extension of the cyclic prefix of the PSSCH/PSCCH AGC symbol #0 106.

### Exemplary Method 2: A Multiple CRS Transmission Scheme for PSSCH/PSCCH With Full Set of RBs and Multiple Sets of RBs (Multiple S_{RB})

In some embodiments, in SL resource allocation Mode 2, as described previously, a TX UE performs sensing and select resources for transmission autonomously on its own for the main purpose of avoiding transmission collision. However, not all transmission collisions can be avoided, for example, when two UEs both performing their initial transmissions of a transport block (TB) and no prior resource reservation can be indicated in SCI before the transmissions. Hence, it is not possible for either UE to know the other UE's intention to transmit in the same slot and their selected resources are overlapping. On the other hand, without knowing other UE's intention and resource allocation does not always equate to collision will occur in the case of initial transmission of a TB from more than one UE in the same slot. These transmissions could occupy only partial bandwidth of an unlicensed channel and they do not have an overlapped frequency resource.

In the case when one of the initial transmissions occupies the entire bandwidth of an unlicensed channel, the full set of resource blocks (RBs) within the channel, then TX collision may be unavoidable/inevitable in the same slot between the different PSSCH/PSCCH transmitting UEs. In the earlier version of the SL communication, this problem is never solved. In Method 2, it is proposed to resolve this problem by using CRS transmission before the starting symbol for PSSCH/PSCCH.

In some embodiments, in Method 2, it is proposed to determine the time length duration/starting position of CRS transmission based on at least a priority level or channel access priority class of the PSSCH/PSCCH transmission, and/or the resource allocation for the PSSCH/PSCCH transmission within the unlicensed spectrum. It is mentioned earlier that if a UE's access to an unlicensed channel is based on the priority level of the data to be transmitted, then lower priority data will be always blocked by higher priority ones and FDM of transmissions of different UEs with different priority level will not be possible. However, in the case of PSSCH/PSCCH transmission with full occupancy of at least one shared unlicensed channel, i.e., full set of RBs or multiple sets of RBs, it is more efficient to allow higher priority transmission to obtain the access to the unlicensed channel (and block/prevent the lower priority ones to transmit) rather than allowing every UE to transmit, causing Tx collisions and resulting in receiver UE failing to decode any of the transmissions.

In the proposed Method 2, several CRS time lengths/starting positions are pre-defined or (pre-)configuration in a resource pool according to the existing eight L1 priority levels or the four channel access priority classes (p). For a higher priority level/lower CAPC value, the longer the CRS time length duration/earlier the starting positioning within the GP symbol. This means, the UE could complete the channel access procedure earlier for a higher priority PSSCH/PSCCH and start the CRS transmission earlier within the GP symbol/before the start of the AGC symbol. As a result, for a lower priority PSSCH/PSCCH that uses a later CRS starting position, the UE would not be able to complete its channel access procedure due to blocking by earlier starting CRS for higher priority TX.

Note that, in SL communication, a higher priority level is assigned with a lower priority number/value. For example, the highest priority in PSSCH/PSCCH transmission is assigned with a L1 priority value of 1, and the lowest priority is assigned with a value 8. Similar assignment is applied in channel access priority class. The highest priority class is 1 and the lowest priority class is 4.

In reference to diagram 200 in FIG. 6, an exemplary illustration of the proposed priority level based selection of CRS time length/starting position is shown for the case of first starting symbol for PSSCH/PSCCH transmission within a slot. The proposed Method 2 can be similarly applied to the case of second starting symbol for PSSCH/PSCCH transmission within a slot. As illustrated, the last two OFDM symbols of slot k consists of a symbol index #12 201 which could be a PSFCH or PSSCH symbol and a symbol index #13 202 which is always a GP symbol at the end of a slot. In slot k+1, the first symbol index #0 203 is always a AGC symbol for the subsequent PSSCH/PSCCH transmission in the same slot. Within the GP symbol #13 202, four CRS time lengths/starting positions are pre-defined/(pre-)configured corresponding to the 4 SL channel access priority classes (p). These are denoted as time length/starting position “a” 204, “b” 205, “c” 206, and “d” 207. According to the earlier description, the time length/starting position “a” 204 would correspond to the highest CAPC level p=1. The time length/starting position “b” 205 would correspond to the highest CAPC level p=2, and so on.

In some examples, the remaining gap within the GP symbol #13 would be the time length “e” 208 as illustrated in diagram 200. This gap length “e” should be used by the UE to complete the channel access procedure. For the case of UE performing Type 2C channel access procedure, where the maximum required channel idle is 16 μs, and the UE will need at least 13 μs to perform RX/TX switching, it means the shortest time length for “e” 208 would be 13 μs. And since the required time length to complete the short LBT in Type 1 channel access procedure is 34 μs, which is longer than the 25 μs in Type 2A and the 16 μs in Type 2B, it means the longest time length for “e” 208 would be 34 μs.

In some embodiments, for the proposed CRS transmitting Method 1 and Method 2 described in the present disclosure of inventions, they can be used independently from each other in a resource pool or they can be jointly used/coexist in the same resource pool. That is, when they are used independently, only Method 1 for a common/single CRS time length/starting position is (pre-)configured or only Method 2 for a priority-based selection of CRS time length/starting position is (pre-)configured in a resource pool. For the case of both a common/single CRS time length/starting position in Method 1 and multiple CRS time lengths/starting positions in Method 2 are (pre-)configured, UE selection between CRS transmitting Method 1 and Method 2 could be based on whether the PSSCH/PSCCH transmission occupies the full set(s) of RBs in an unlicensed channel. In a SL-U system when both proposed Method 1 and Method 2 are (pre-)configured, it creates a flexibility in determining the degree in which the FDM or TDM type of SL transmission should be supported in the unlicensed spectrum. For example, if TDM-based SL transmission and channel access is more beneficial and preferred, the single CRS time length/starting position in Method 1 could be set to a shorter length/a later starting position, such that TDM-based transmissions will transmit CRS earlier than the FDM-based ones. On the opposite, the single CRS time length/starting position in Method 1 could be set to a longer length/an earlier starting position, if FDM-based SL transmission is more dominant.

Note that, the term “pre-defined” or “pre-defined rules” in the present disclosure may be achieved by pre-storing corresponding codes, tables or other manners for indicating relevant information in devices (e.g., including a UE and a network device). The specific implementation is not limited in the present disclosure. For example, “pre-defined” may refer to those defined in a protocol. It is also to be understood that in the disclosure, “protocol” may refer to a standard protocol in the field of communication, which may include, for example, a (long term evolution) LTE protocol, (new radio) NR protocol and relevant protocol applied in the future communication system, which is not limited in the present disclosure.

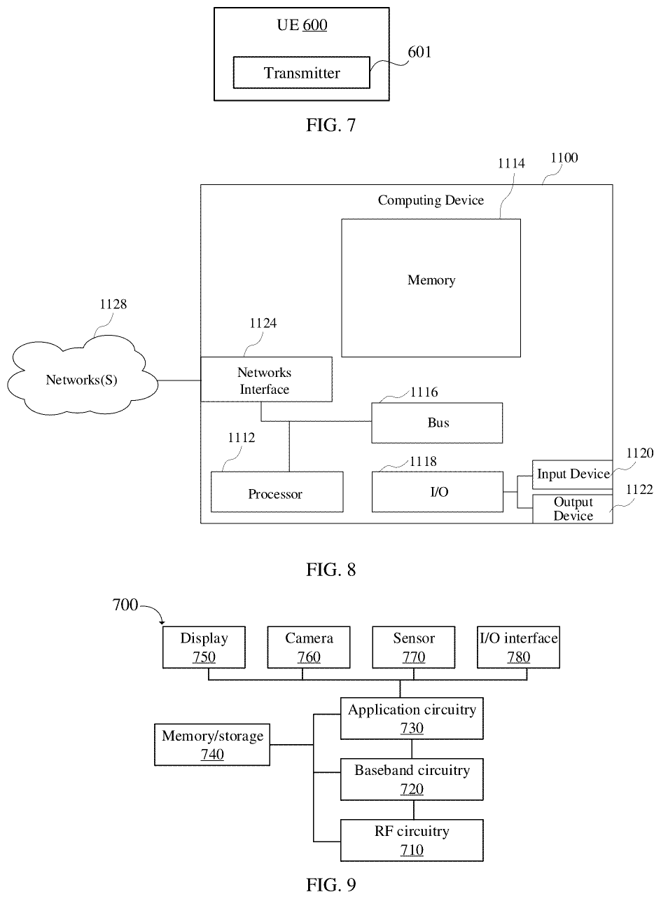

FIG. 7 illustrates a UE 600 for wireless communication according to an embodiment of the present disclosure. The UE 600 includes a transmitter 601 configured to transmit one CRS from one or multiple CRS starting positions for a SL transmission within a first orthogonal frequency division multiplex (OFDM) symbol prior to a start of the SL transmission, wherein the one or multiple CRS starting positions for the SL transmission are configured and the SL transmission includes a SL synchronization signals block (S-SSB) transmission, a physical sidelink feedback channel (PSFCH) transmission, a physical sidelink shared channel (PSSCH) transmission, and/or a physical sidelink control channel (PSCCH) transmission. This can solve issues in the prior art and other issues, and/or improve SL communication performance and reliability.

In some embodiments, the one CRS starting position for the S-SSB transmission, the PSFCH transmission, the PSSCH transmission, and/or the PSCCH transmission is configured from one of pre-defined candidate starting positions. In some embodiments, the one CRS starting position for the S-SSB transmission within the first OFDM symbol prior to a start of the S-SSB transmission is common for UEs. In some embodiments, the one CRS starting position for the PSFCH transmission, the PSSCH transmission, and/or the PSCCH transmission within the first OFDM symbol prior to a start of an automatic gain control (AGC) symbol for the PSFCH transmission, the PSSCH transmission, and/or the PSCCH transmission is common for UEs. In some embodiments, a selection of the one CRS starting position for the PSSCH transmission and/or the PSCCH transmission is based on the PSSCH transmission and/or the PSCCH transmission occupying less than a full bandwidth of a shared/unlicensed channel.

In some embodiments, the one CRS for the S-SSB transmission, the PSFCH transmission, the PSSCH transmission, and/or the PSCCH transmission is transmitted a time length before an automatic gain control (AGC) symbol for the S-SSB transmission, the PSFCH transmission, the PSSCH transmission, and/or the PSCCH transmission or before a first symbol of the S-SSB transmission, the PSFCH transmission, the PSSCH transmission, and/or the PSCCH transmission. In some embodiments, for 15 kHz sub-carrier spacing (SCS) and/or 30 kHz SCS, the one CRS starting position for the S-SSB transmission, the PSFCH transmission, the PSSCH transmission, and/or the PSCCH transmission is determined by (an OFDM symbol length−34 μs), (the OFDM symbol length−25 μs), or (the OFDM symbol length−16 μs). In some embodiments, for 60 kHz SCS, the one CRS starting position for the S-SSB transmission, the PSFCH transmission, the PSSCH transmission, and/or the PSCCH transmission is determined by (an OFDM symbol length−16 μs).

In some embodiments, the one CRS for the S-SSB transmission, the PSFCH transmission, the PSSCH transmission, and/or the PSCCH transmission includes a repetition or an extension of a cyclic prefix of the AGC symbol for the S-SSB transmission, the PSFCH transmission, the PSSCH transmission, and/or the PSCCH transmission or a repetition or an extension of a cyclic prefix of the first symbol of the S-SSB transmission, the PSFCH transmission, the PSSCH transmission, and/or the PSCCH transmission. In some embodiments, the multiple CRS starting positions for the PSSCH transmission and/or the PSCCH transmission are configured from a set of pre-defined candidate starting positions. In some embodiments, the multiple CRS starting positions for the PSSCH transmission and/or the PSCCH transmission are configured based on first layer (L1) priority levels. In some embodiments, in the L1 priority levels, for a first priority level higher than a second priority level, a CRS time length duration of the first priority level is longer than CRS time length duration of the second priority level.

In some embodiments, the term “/” can be interpreted to indicate “and/or.” The term “configured” can refer to “pre-configured” and “network configured”. The term “pre-defined” or “pre-defined rules” in the present disclosure may be achieved by pre-storing corresponding codes, tables, or other manners for indicating relevant information in devices (e.g., including a UE and a network device). The specific implementation is not limited in the present disclosure. For example, “pre-defined” may refer to those defined in a protocol. It is also to be understood that in the disclosure, “protocol” may refer to a standard protocol in the field of communication, which may include, for example, an LTE protocol, NR protocol and relevant protocol applied in the future communication system, which is not limited in the present disclosure.

In summary, in some embodiments, in order to ensure a success channel access after UE performed a Type 1 channel access procedure or a success in retaining a channel access in UE performing a Type 2 channel access procedure, it is proposed in the present invention disclosure to transmit a channel retention signal (CRS) during a transmission gap in the existing frame structure of SL transmission according to one of the following two methods. The proposed methods also help to resolve a channel access prevention issue among different SL transmitting UEs, where one UE's transmission/occupation of the channel will prevent other UEs to access the same channel. Exemplary method 1 provides a single/common CRS transmission scheme for PSFCH/S-SSB and PSSCH/PSCCH. Exemplary method 2 provides a multiple CRS transmission scheme for PSSCH/PSCCH.

Commercial interests for some embodiments are as follows. 1. Solving issues in the prior art and other issues. 2. Improving a sidelink (SL) communication performance. 3. Access to the unlicensed channel is maintained for the intended SL transmission. 4. Avoiding SL transmission collision in the case when the intended SL transmission occupies at least full bandwidth of a channel based on a priority-based access. 5. The CRS transmission can be flexibly adjusted to prioritize FDM or TDM based transmission according to the application and use case (e.g., TDM based setting for data intensive applications and FDM based setting for latency sensitive usage). 6. Some embodiments of the present disclosure are used by 5G-NR chipset vendors, V2X communication system development vendors, automakers including cars, trains, trucks, buses, bicycles, moto-bikes, helmets, and etc., drones (unmanned aerial vehicles), smartphone makers, smart watches, wireless earbuds, wireless headphones, communication devices, remote control vehicles, and robots for public safety use, AR/VR device maker for example gaming, conference/seminar, education purposes, smart home appliances including TV, stereo, speakers, lights, door bells, locks, cameras, conferencing headsets, and etc., smart factory and warehouse equipment including IIoT devices, robots, robotic arms, and simply just between production machines. In some embodiments, commercial interest for the disclosed invention and business importance includes lowering power consumption for wireless communication means longer operating time for the device and/or better user experience and product satisfaction from longer operating time between battery charging. Some embodiments of the present disclosure are a combination of “techniques/processes” that can be adopted in 3GPP specification to create an end product. Some embodiments of the present disclosure relate to mobile cellular communication technology in 3GPP NR Releases 17, 18, 19, and beyond for providing direct device-to-device (D2D) wireless communication services.

FIG. 8 is a block diagram of an example of a computing device according to an embodiment of the present disclosure. Any suitable computing device can be used for performing the operations described herein. For example, FIG. 8 illustrates an example of the computing device 1100 that can implement some embodiments in FIG. 1 to FIG. 7, using any suitably configured hardware and/or software. In some embodiments, the computing device 1100 can include a processor 1112 that is communicatively coupled to a memory 1114 and that executes computer-executable program code and/or accesses information stored in the memory 1114. The processor 1112 may include a microprocessor, an application-specific integrated circuit (“ASIC”), a state machine, or other processing device. The processor 1112 can include any of a number of processing devices, including one. Such a processor can include or may be in communication with a computer-readable medium storing instructions that, when executed by the processor 1112, cause the processor to perform the operations described herein.

The memory 1114 can include any suitable non-transitory computer-readable medium. The computer-readable medium can include any electronic, optical, magnetic, or other storage device capable of providing a processor with computer-readable instructions or other program code. Non-limiting examples of a computer-readable medium include a magnetic disk, a memory chip, a read-only memory (ROM), a random access memory (RAM), an application specific integrated circuit (ASIC), a configured processor, optical storage, magnetic tape or other magnetic storage, or any other medium from which a computer processor can read instructions. The instructions may include processor-specific instructions generated by a compiler and/or an interpreter from code written in any suitable computer-programming language, including, for example, C, C++, C#, visual basic, java, python, perl, javascript, and actionscript.

The computing device 1100 can also include a bus 1116. The bus 1116 can communicatively couple one or more components of the computing device 1100. The computing device 1100 can also include a number of external or internal devices such as input or output devices. For example, the computing device 1100 is illustrated with an input/output (“I/O”) interface 1118 that can receive input from one or more input devices 1120 or provide output to one or more output devices 1122. The one or more input devices 1120 and one or more output devices 1122 can be communicatively coupled to the I/O interface 1118. The communicative coupling can be implemented via any suitable manner (e.g., a connection via a printed circuit board, connection via a cable, communication via wireless transmissions, etc.). Non-limiting examples of input devices 1120 include a touch screen (e g., one or more cameras for imaging a touch area or pressure sensors for detecting pressure changes caused by a touch), a mouse, a keyboard, or any other device that can be used to generate input events in response to physical actions by a user of a computing device. Non-limiting examples of output devices 1122 include a liquid crystal display (LCD) screen, an external monitor, a speaker, or any other device that can be used to display or otherwise present outputs generated by a computing device.

The computing device 1100 can execute program code that configures the processor 1112 to perform one or more of the operations described above with respect to FIG. 1 to FIG. 7. The program code may be resident in the memory 1114 or any suitable computer-readable medium and may be executed by the processor 1112 or any other suitable processor.

The computing device 1100 can also include at least one network interface device 1124. The network interface device 1124 can include any device or group of devices suitable for establishing a wired or wireless data connection to one or more data networks 1128. Non limiting examples of the network interface device 1124 include an Ethernet network adapter, a modem, and/or the like. The computing device 1100 can transmit messages as electronic or optical signals via the network interface device 1124.

FIG. 9 is a block diagram of an example system 700 for wireless communication according to an embodiment of the present disclosure. Embodiments described herein may be implemented into the system using any suitably configured hardware and/or software. FIG. 9 illustrates the system 700 including a radio frequency (RF) circuitry 710, a baseband circuitry 720, an application circuitry 730, a memory/storage 740, a display 750, a camera 760, a sensor 770, and an input/output (I/O) interface 780, coupled with each other at least as illustrated.

The application circuitry 730 may include a circuitry such as, but not limited to, one or more single-core or multi-core processors. The processors may include any combination of general-purpose processors and dedicated processors, such as graphics processors, application processors. The processors may be coupled with the memory/storage and configured to execute instructions stored in the memory/storage to enable various applications and/or operating systems running on the system.

The baseband circuitry 720 may include circuitry such as, but not limited to, one or more single-core or multi-core processors. The processors may include a baseband processor. The baseband circuitry may handle various radio control functions that enables communication with one or more radio networks via the RF circuitry. The radio control functions may include, but are not limited to, signal modulation, encoding, decoding, radio frequency shifting, etc. In some embodiments, the baseband circuitry may provide for communication compatible with one or more radio technologies. For example, in some embodiments, the baseband circuitry may support communication with an evolved universal terrestrial radio access network (EUTRAN) and/or other wireless metropolitan area networks (WMAN), a wireless local area network (WLAN), a wireless personal area network (WPAN). Embodiments in which the baseband circuitry is configured to support radio communications of more than one wireless protocol may be referred to as multi-mode baseband circuitry.

In various embodiments, the baseband circuitry 720 may include circuitry to operate with signals that are not strictly considered as being in a baseband frequency. For example, in some embodiments, baseband circuitry may include circuitry to operate with signals having an intermediate frequency, which is between a baseband frequency and a radio frequency.

The RF circuitry 710 may enable communication with wireless networks using modulated electromagnetic radiation through a non-solid medium. In various embodiments, the RF circuitry may include switches, filters, amplifiers, etc. to facilitate the communication with the wireless network.

In various embodiments, the RF circuitry 710 may include circuitry to operate with signals that are not strictly considered as being in a radio frequency. For example, in some embodiments, RF circuitry may include circuitry to operate with signals having an intermediate frequency, which is between a baseband frequency and a radio frequency.

In various embodiments, the transmitter circuitry, control circuitry, or receiver circuitry discussed above with respect to the user equipment, eNB, or gNB may be embodied in whole or in part in one or more of the RF circuitry, the baseband circuitry, and/or the application circuitry. As used herein, “circuitry” may refer to, be part of, or include an application specific integrated circuit (ASIC), an electronic circuit, a processor (shared, dedicated, or group), and/or a memory (shared, dedicated, or group) that execute one or more software or firmware programs, a combinational logic circuit, and/or other suitable hardware components that provide the described functionality. In some embodiments, the electronic device circuitry may be implemented in, or functions associated with the circuitry may be implemented by, one or more software or firmware modules.

In some embodiments, some or all of the constituent components of the baseband circuitry, the application circuitry, and/or the memory/storage may be implemented together on a system on a chip (SOC).

The memory/storage 740 may be used to load and store data and/or instructions, for example, for system. The memory/storage for one embodiment may include any combination of suitable volatile memory, such as dynamic random access memory (DRAM)), and/or non-volatile memory, such as flash memory.

In various embodiments, the I/O interface 780 may include one or more user interfaces designed to enable user interaction with the system and/or peripheral component interfaces designed to enable peripheral component interaction with the system. User interfaces may include, but are not limited to a physical keyboard or keypad, a touchpad, a speaker, a microphone, etc. Peripheral component interfaces may include, but are not limited to, a non-volatile memory port, a universal serial bus (USB) port, an audio jack, and a power supply interface.

In various embodiments, the sensor 770 may include one or more sensing devices to determine environmental conditions and/or location information related to the system. In some embodiments, the sensors may include, but are not limited to, a gyro sensor, an accelerometer, a proximity sensor, an ambient light sensor, and a positioning unit. The positioning unit may also be part of, or interact with, the baseband circuitry and/or RF circuitry to communicate with components of a positioning network, e.g., a global positioning system (GPS) satellite.

In various embodiments, the display 750 may include a display, such as a liquid crystal display and a touch screen display. In various embodiments, the system 700 may be a mobile computing device such as, but not limited to, a laptop computing device, a tablet computing device, a netbook, an ultrabook, a smartphone, a AR/VR glasses, etc. In various embodiments, system may have more or less components, and/or different architectures. Where appropriate, methods described herein may be implemented as a computer program. The computer program may be stored on a storage medium, such as a non-transitory storage medium.

A person having ordinary skill in the art understands that each of the units, algorithm, and steps described and disclosed in the embodiments of the present disclosure are realized using electronic hardware or combinations of software for computers and electronic hardware. Whether the functions run in hardware or software depends on the condition of application and design requirement for a technical plan.

A person having ordinary skill in the art can use different ways to realize the function for each specific application while such realizations cannot go beyond the scope of the present disclosure. It is understood by a person having ordinary skill in the art that he/she can refer to the working processes of the system, device, and unit in the above-mentioned embodiment since the working processes of the above-mentioned system, device, and unit are basically the same. For easy description and simplicity, these working processes will not be detailed.

It is understood that the disclosed system, device, and method in the embodiments of the present disclosure can be realized with other ways. The above-mentioned embodiments are exemplary only. The division of the units is merely based on logical functions while other divisions exist in realization. It is possible that a plurality of units or components are combined or integrated in another system. It is also possible that some characteristics are omitted or skipped. On the other hand, the displayed or discussed mutual coupling, direct coupling, or communicative coupling operate through some ports, devices, or units whether indirectly or communicatively by ways of electrical, mechanical, or other kinds of forms.

The units as separating components for explanation are or are not physically separated. The units for display are or are not physical units, that is, located in one place or distributed on a plurality of network units. Some or all of the units are used according to the purposes of the embodiments. Moreover, each of the functional units in each of the embodiments can be integrated in one processing unit, physically independent, or integrated in one processing unit with two or more than two units.

If the software function unit is realized and used and sold as a product, it can be stored in a readable storage medium in a computer. Based on this understanding, the technical plan proposed by the present disclosure can be essentially or partially realized as the form of a software product. Or, one part of the technical plan beneficial to the conventional technology can be realized as the form of a software product. The software product in the computer is stored in a storage medium, including a plurality of commands for a computational device (such as a personal computer, a server, or a network device) to run all or some of the steps disclosed by the embodiments of the present disclosure. The storage medium includes a USB disk, a mobile hard disk, a read-only memory (ROM), a random access memory (RAM), a floppy disk, or other kinds of media capable of storing program codes.

While the present disclosure has been described in connection with what is considered the most practical and preferred embodiments, it is understood that the present disclosure is not limited to the disclosed embodiments but is intended to cover various arrangements made without departing from the scope of the broadest interpretation of the appended claims.

What is claimed is:

1. A method for transmitting channel retention signal (CRS) in sidelink (SL) communication by a user equipment (UE), comprising:
transmitting, by the UE, one CRS from one or multiple CRS starting positions for an SL transmission within a first orthogonal frequency division multiplex (OFDM) symbol prior to a start of the SL transmission, wherein the one or multiple CRS starting positions for the SL transmission are configured and the SL transmission comprises a SL synchronization signals block (S-SSB) transmission, a physical sidelink feedback channel (PSFCH) transmission, a physical sidelink shared channel (PSSCH) transmission, and/or a physical sidelink control channel (PSCCH) transmission.

2. The method of claim 1, wherein the one CRS starting position for the S-SSB transmission, the PSFCH transmission, the PSSCH transmission, and/or the PSCCH transmission is configured from one of pre-defined candidate starting positions.

3. The method of claim 1, wherein the one CRS starting position for the S-SSB transmission within the first OFDM symbol prior to a start of the S-SSB transmission is common for UEs.

4. The method of claim 1, wherein the one CRS starting position for the PSFCH transmission, the PSSCH transmission, and/or the PSCCH transmission within the first OFDM symbol prior to a start of an automatic gain control (AGC) symbol for the PSFCH transmission, the PSSCH transmission, and/or the PSCCH transmission is common for UEs.

5. The method of claim 1, wherein the one CRS for the S-SSB transmission, the PSFCH transmission, the PSSCH transmission, and/or the PSCCH transmission is transmitted a time length before an automatic gain control (AGC) symbol for the S-SSB transmission, the PSFCH transmission, the PSSCH transmission, and/or the PSCCH transmission or before a first symbol of the S-SSB transmission, the PSFCH transmission, the PSSCH transmission, and/or the PSCCH transmission.

6. The method of claim 5, wherein for 15 kHz sub-carrier spacing (SCS) and/or 30 kHz SCS, the one CRS starting position for the S-SSB transmission, the PSFCH transmission, the PSSCH transmission, and/or the PSCCH transmission is determined by (an OFDM symbol length−34 μs), (the OFDM symbol length−25 μs), or (the OFDM symbol length−16 μs).

7. The method of claim 5, wherein for 60 kHz SCS, the one CRS starting position for the S-SSB transmission, the PSFCH transmission, the PSSCH transmission, and/or the PSCCH transmission is determined by (an OFDM symbol length−16 μs).

8. The method of claim 5, wherein the one CRS for the S-SSB transmission, the PSFCH transmission, the PSSCH transmission, and/or the PSCCH transmission comprises a repetition or an extension of a cyclic prefix of the AGC symbol for the S-SSB transmission, the PSFCH transmission, the PSSCH transmission, and/or the PSCCH transmission or a repetition or an extension of a cyclic prefix of the first symbol of the S-SSB transmission, the PSFCH transmission, the PSSCH transmission, and/or the PSCCH transmission.

9. The method of claim 1, wherein the multiple CRS starting positions for the PSSCH transmission and/or the PSCCH transmission are configured from a set of pre-defined candidate starting positions.

10. A user equipment (UE), comprising:
a transmitter configured to transmit one CRS from one or multiple CRS starting positions for a SL transmission within a first orthogonal frequency division multiplex (OFDM) symbol prior to a start of the SL transmission, wherein the one or multiple CRS starting positions for the SL transmission are configured and the SL transmission comprises a SL synchronization signals block (S-SSB) transmission, a physical sidelink feedback channel (PSFCH) transmission, a physical sidelink shared channel (PSSCH) transmission, and/or a physical sidelink control channel (PSCCH) transmission.

11. The UE of claim 10, wherein the one CRS starting position for the S-SSB transmission, the PSFCH transmission, the PSSCH transmission, and/or the PSCCH transmission is configured from one of pre-defined candidate starting positions.

12. The UE of claim 10, wherein the one CRS starting position for the S-SSB transmission within the first OFDM symbol prior to a start of the S-SSB transmission is common for UEs.

13. The UE of claim 10, wherein the one CRS starting position for the PSFCH transmission, the PSSCH transmission, and/or the PSCCH transmission within the first OFDM symbol prior to a start of an automatic gain control (AGC) symbol for the PSFCH transmission, the PSSCH transmission, and/or the PSCCH transmission is common for UEs.

14. The UE of claim 10, wherein the one CRS for the S-SSB transmission, the PSFCH transmission, the PSSCH transmission, and/or the PSCCH transmission is transmitted a time length before an automatic gain control (AGC) symbol for the S-SSB transmission, the PSFCH transmission, the PSSCH transmission, and/or the PSCCH transmission or before a first symbol of the S-SSB transmission, the PSFCH transmission, the PSSCH transmission, and/or the PSCCH transmission.

15. The UE of claim 14, wherein for 15 kHz sub-carrier spacing (SCS) and/or 30 kHz SCS, the one CRS starting position for the S-SSB transmission, the PSFCH transmission, the PSSCH transmission, and/or the PSCCH transmission is determined by (an OFDM symbol length−34 μs), (the OFDM symbol length−25 μs), or (the OFDM symbol length−16 μs).

16. The UE of claim 14, wherein for 60 kHz SCS, the one CRS starting position for the S-SSB transmission, the PSFCH transmission, the PSSCH transmission, and/or the PSCCH transmission is determined by (an OFDM symbol length−16 μs).

17. The UE of claim 14, wherein the one CRS for the S-SSB transmission, the PSFCH transmission, the PSSCH transmission, and/or the PSCCH transmission comprises a repetition or an extension of a cyclic prefix of the AGC symbol for the S-SSB transmission, the PSFCH transmission, the PSSCH transmission, and/or the PSCCH transmission or a repetition or an extension of a cyclic prefix of the first symbol of the S-SSB transmission, the PSFCH transmission, the PSSCH transmission, and/or the PSCCH transmission.

18. The UE of claim 10, wherein the multiple CRS starting positions for the PSSCH transmission and/or the PSCCH transmission are configured based on first layer (L1) priority levels.

19. The UE of claim 18, wherein in the L1 priority levels, for a first priority level higher than a second priority level, a CRS time length duration of the first priority level is longer than CRS time length duration of the second priority level.

20. A non-transitory machine-readable storage medium having stored thereon instructions that, when executed by a user equipment (UE), cause the UE to perform an operation of:
transmitting, by the UE, one channel retention signal (CRS) from one or multiple CRS starting positions for a sidelink (SL) transmission within a first orthogonal frequency division multiplex (OFDM) symbol prior to a start of the SL transmission, wherein the one or multiple CRS starting positions for the SL transmission are configured and the SL transmission comprises a SL synchronization signals block (S-SSB) transmission, a physical sidelink feedback channel (PSFCH) transmission, a physical sidelink shared channel (PSSCH) transmission, and/or a physical sidelink control channel (PSCCH) transmission.
